(19) United States
(12) Patent Application Publication
(10) Pub. No.: US 2006/0194088 A1
(43) Pub. Date: Aug. 31, 2006

(54) Compound membrane and fuel cell using the same

(75) Inventor: Hiroki Kabumoto, Saitama-Shi (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/363,187

(22) Filed: Feb. 28, 2006

(30) Foreign Application Priority Data
Feb. 28, 2005 (JP) 2005-054193
Apr. 28, 2005 (JP) 2005-131012

(51) Int. Cl. H01M 8/10; C08J 5/22

(52) U.S. Cl. 429/30; 521/27; 429/32

(57) ABSTRACT

A compound membrane that can connect the cells of planar array fuel cells in a simple manner is provided, along with a fuel cell that uses such a compound membrane to obtain any desired current and voltage. The compound membrane has a plurality of regions with different properties. The membrane includes a plurality of first regions that conduct protons between first and second main surfaces, and a second region that conducts electrons between the first and second main surfaces. The fuel cell using the compound membrane includes a plurality of first electrodes, a plurality of second electrodes, a first electron conductive member that connects one of the first electrodes to the second region, and a second electron conductive member that connects one of the second electrodes to the second region.

### BACKGROUND OF INVENTION

1. Field of the Invention

The present invention relates to a compound membrane and a fuel cell using such a compound membrane. More particularly, the present invention relates to a compound membrane that can connect the cells of planar fuel cells in a simple manner, as well as to a fuel cell using such a compound membrane.

2. Description of the Related Art

A fuel cell is a device that can generate electric energy from hydrogen and oxygen and can achieve high power efficiency. As opposed to conventional power generating systems, which require conversion of heat energy and kinetic energy into electricity, fuel cells can directly generate power and can thus achieve high power efficiency at small scales. In addition, fuel cells produce less waste such as nitrogen compounds, cause little noises and vibrations and thus do less harm to the environment. Utilizing chemical energy of the fuels and causing less harm to the environment, fuel cells are expected to serve as the energy supply system of the 21st century and have attracted much attention as a promising power generating system that can be used in a wide range of applications, ranging from space technologies and automobiles to portable devices, from large scale to small scale power generation. Thus, significant effort has been devoted to developing this technology.

Proton-exchange membrane fuel cells can operate at lower temperatures and generate power at higher power density as compared to other types of fuel cell. In recent years, one type of proton-exchange membrane fuel cell has drawn particular attention: Direct methanol fuel cells (DMFCs). DMFCs operate by directly feeding aqueous methanol fuel to the anode without any modification. Power is generated by the electrochemical reaction of the methanol solution with oxygen. During this reaction, carbon dioxide is discharged from the anode and water is discharged from the cathode as reaction products. Since methanol aqueous solution can generate more energy per unit volume than hydrogen and is suitable for storage, posing less risk of explosion, DMFCs are expected to become widely used as power sources for automobiles and various portable devices (such as a cell phone, a laptop computer, a PDA, an MP3 player, a digital camera, and an electronic dictionary (book)).

Unlike common fuel cells that are constructed as a stack of cells to obtain increased voltages required for desired purposes, DMFCs for use in portable devices do not require high voltages, but, rather, they must be constructed as thin as possible. For this reason, DMFCs are generally formed as a planar structure (for example, see Japanese Patent Laid-Open No. 2003-197225).

### SUMMARY OF THE INVENTION

As opposed to stacked cells, cells in the planar array fuel cells are difficult to connect in series. To address this problem, Japanese Patent Laid-Open No. 2003-197225 proposes a wiring connection that extends through a solid polymer membrane. This approach has a drawback that the solid polymer membrane is subjected to excessive stress in the area through which the wiring connection extends.

The present invention addresses this problem: It is an object of the present invention to provide a compound membrane that can connect the cells of planar array fuel cells in a simple manner, as well as a fuel cell that uses this compound membrane to obtain any desired current or voltage.

To achieve the above-described object, one of the aspects of the present invention provides a compound membrane that has a plurality of regions with different properties. This compound membrane comprises a plurality of first regions that conduct protons between first and second main surfaces, and a second region that conducts electrons between the first and second main surfaces. When used to make planar array fuel cells, this compound membrane allows connection of the cells of planar array fuel cells in a simple manner.

In the above-described aspect, the compound membrane may comprise an insulative third region that separates the first regions from one another. The compound membrane according to the above aspect may include an insulative porous substrate, the first regions may be formed by filling the substrate with a proton conductive material and the second region may be formed by filling the substrate with an electron conductive material. This facilitates the production of the compound membrane.

Another aspect of the present invention provides a fuel cell that comprises any of the compound membranes described above; a plurality of first electrodes arranged on the first main surface, the first electrodes corresponding to, and arranged opposed to, the first regions; a plurality of second electrodes arranged on the second main surface, the second electrodes corresponding to, and arranged opposed to, the first regions; a first electron conductive member that connects one of the first electrodes to the second region on the first main surface; and a second electron conductive member that connects one of the second electrodes that is not opposed to the one of the first electrode to the second region on the second main surface. This construction allows the cells of the planar array fuel cell to be connected in a simple manner and makes it possible to obtain any desired current and voltage by changing the way the cells are arranged or connected with each other.

In this aspect, a region of the compound membrane other than the first regions and the second region may not be permeable to any fluids other than water. This prevents cross-leakages and helps improve the efficiency of the fuel cell.

It is to be noted that any arbitrary combination or rearrangement of the above-described structural components and so forth are all effective as and encompassed by the present embodiments.

Moreover, this summary of the invention does not necessarily describe all necessary features so that the invention may also be sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a schematic view showing a production process of the insulation area of a compound membrane according to a first embodiment;

FIG. 2 is a schematic view showing a production process of the connector areas and power generating areas of the compound membrane according to the first embodiment;

FIG. 3 is a perspective view showing the construction of a fuel cell according to the first embodiment;

FIG. 4 is a cross-sectional view of the fuel cell according to the first embodiment;

FIG. 5 is an exploded perspective view showing a basic construction of a DMFC according to a second embodiment;

FIG. 6 is a schematic top view showing one construction of MEA according to Example 1 of the second embodiment;

FIG. 7 is a schematic perspective view showing another construction of MEA according to Example 2 of the second embodiment;

FIG. 8 is a schematic top view showing another construction of MEA according to Example 3 of the second embodiment.

### DETAILED DESCRIPTION OF THE INVENTION

### First Embodiment

A production process of a first embodiment of compound membrane 10 will now be described with reference to the accompanying drawings.

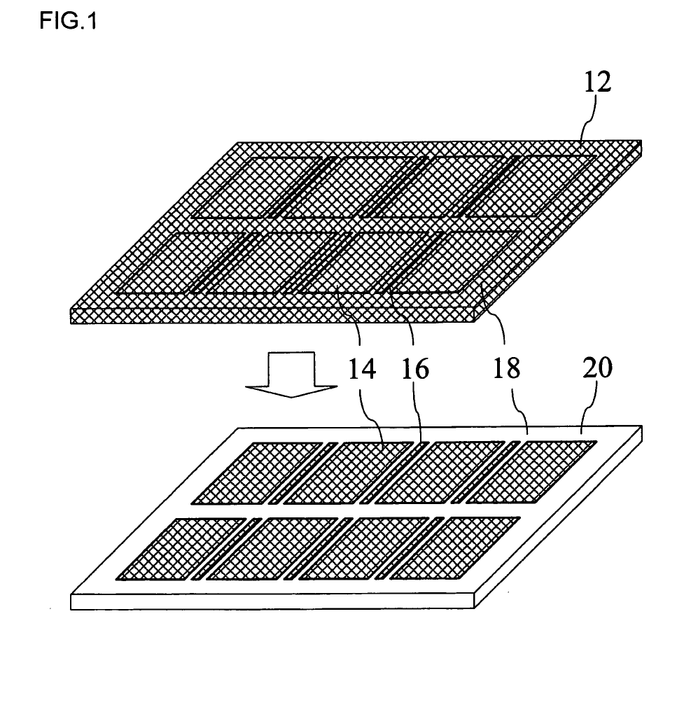

The compound membrane 10 comprises a substrate 12 that comprises an approximately 50 μm-thick nonwoven fabric formed of a fibrous fluorine resin (referred to as “porous fluorine film,” hereinafter). As shown in FIG. 1, the substrate 12 includes power generating areas 14, connector areas 16, and an insulating area 18 that forms the part of the substrate 12 other than the power generating areas 14 and the connector areas 16. The insulating area 18 of the compound membrane 10 is filled with an insulator 20 (in this embodiment, fluorine resin 20) so that the pores of the porous fluorine film 12 are impregnated with the insulator. By initially filling the substrate 12 with the insulator 20 to isolate the power generating areas 14 from the connector areas 16, the proton conductor 22 and the electron conductor 24, which are later added to the substrate 12 to fill the power generating areas 14 and the connector areas 16, can be kept from mixing with each other. In particular, this prevents the power generating areas 14 from short-circuiting with one another.

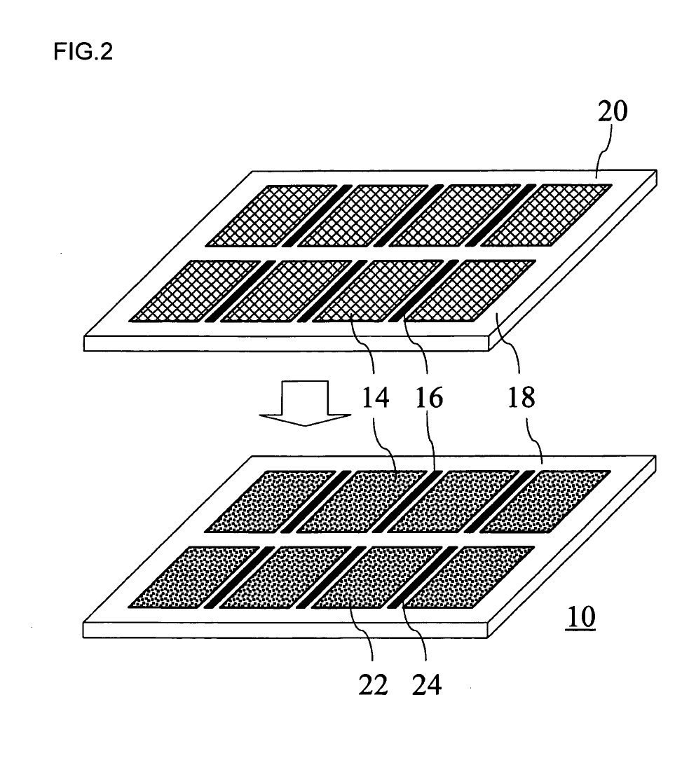

As shown in FIG. 2, the connector areas 16 are then filled with the electron conductor 24 (in this embodiment, powdered carbon black 24 (Vulcan XC-72, CABOT)) so that the pores of the porous fluorine film 12 are impregnated. By arranging rectangular connector areas 16, rather than wiring connections used in conventional fuel cells, on the substrate 12, large connection area (i.e., large cross-sectional area for electron flow) can be ensured and the electrical resistance between the power generating areas 14 can be reduced. This increases the efficiency of power generation. In addition, damage to the fuel cells caused by the leakage of fuels or oxidants or cracking of membrane, which would otherwise take place in the region where wiring connection pierces the membrane, can be prevented. Finally, the power generating areas 14 are filled with the proton conductor 22 (in this embodiment, a 5 wt % Nafion solution 22 (DuPont)) to impregnate the pores of the porous fluorine film 12 and the solvent is evaporated.

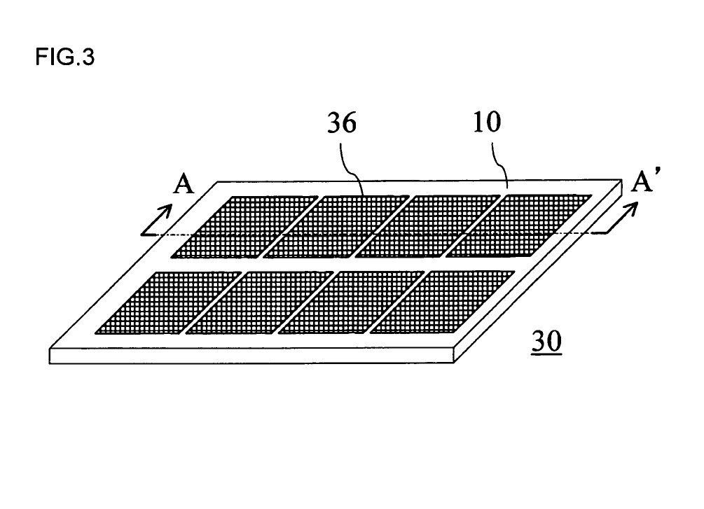

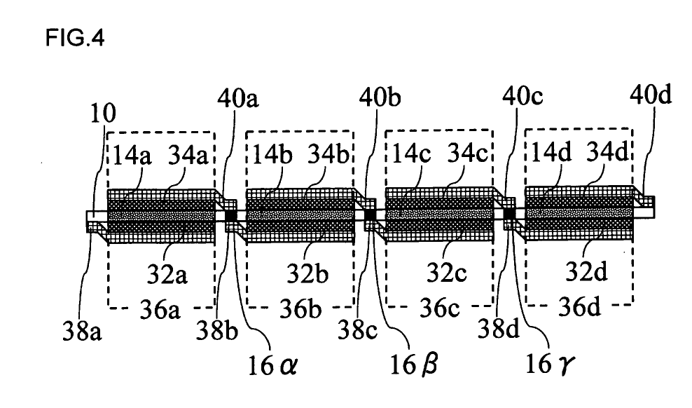

The compound membrane 10 fabricated by the above-described process is then used to construct a planar array fuel cell 30, which will be described in detail with reference to FIGS. 3 and 4. FIG. 3 is a schematic perspective view showing one construction of the planar array fuel cell 30, and FIG. 4 is a cross-sectional view taken along the line A-A′ of FIG. 3.

In FIG. 4, a plurality of anodes are denoted by reference numerals 32. The anodes 32 are formed by applying a catalyst paste, which is a mixture of Pt—Ru black and a 5 wt % Nafion solution (DuPont), to one side of a sheet of hydrophobic carbon paper. The anodes 32 are not shown in FIG. 3 since they are arranged on the bottom surface of the compound membrane 10. The anodes 32 are arranged with the catalyst paste-applied side facing the power generating areas 14, or the areas filled with the proton conductor 22, of the compound membrane 10. Similarly, cathodes, as denoted by reference numerals 34, are formed by applying a catalyst paste, a mixture of Pt-black and a Swt % Nafion solution (DuPont), to one side of a sheet of water-repellant carbon paper impregnated with carbon black (Vulcan XC-72, CABOT). While in this embodiment, the carbon paper is filled with carbon black only on the side facing the cathodes 34, it may be filled with carbon black on both sides (i.e., the side facing the anodes 32 and the side facing the cathodes 34). In such a case, a larger amount of carbon black is preferably used to fill the cathode side of the carbon paper than that used to fill the anode side of the carbon paper. In this manner, the water produced in the cells can readily be discharged from the cathode side of the carbon paper, so that water discharge, as well as air supply, can be smoothly carried out even in the fuel cell systems that have no means to forcibly send air to the cathode side of the carbon paper. The cathodes 34 are arranged on the top surface of the compound membrane 10 with the catalyst paste-applied side facing the power generating areas 14, or the areas filled with the proton conductor 22, of the compound membrane 10.

The anodes 32, the power generating areas 14 of the compound membrane 10, and the cathodes 34 together form a plurality of cells 36. A corresponding number of collectors 38, 40 are arranged outside the cells 36. Each of the collectors 38, 40 is preferably a thin porous element formed of an electron conductive, oxidation-resistant material to allow delivery of fuels and oxidants to each of the cells 36. In this embodiment, the collectors 38, 40 are each a gold mesh. Each anode collector 38 is sized such that it covers one of the anodes 32 and has one end extending beyond the edge of the anode 32 (the left end in the construction shown in FIG. 4) to connect to one of the connector areas 16 of the compound membrane 10. Similarly, each cathode collector 40 is sized such that it covers one of the cathodes 34 and has one end extending beyond the edge of the cathode 34 to connect to one of the connector areas 16 of the compound membrane 10.

In this arrangement, the cathode collector 40a of the cell 36a connects to the anode collector 38b of the cell 36b via the connector area 16α, and the cathode collector 40b of the cell 36b connects to the anode collector 38c of the cell 36c via the connector area 16β, and so on, so that the cells 36a, 36b, 36c, and 36d are connected in series.

Although in this embodiment, a total of 8 cells are arranged in a 2×4 arrangement with the 4 cells in the same row connected in series, it should be readily appreciated by those skilled in the art that changes can be made to the specific embodiment in terms of the number and arrangement of the cell 36, the arrangement of the connector areas 16 and the shapes of the collectors 38, 40 as shown in FIG. 3, to thereby obtain any desired current and voltage from a planar array fuel cell 30 using a single compound membrane 10. While in this embodiment, the catalyst layer is formed by applying a catalyst paste to an electrode substrate such as carbon paper, it may be formed directly on the collectors without using the electrode substrates, or it may be formed on the compound membrane in such a manner that it is sandwiched between electrode substrates and collectors. While the catalyst used in this embodiment is particles of Pt—Ru and Pt (i.e., Pt—Ru black and Pt black), carbon blacks impregnated with catalysts may also be used.

The first embodiment of the compound membrane of the present invention can be applied not only to planar array fuel cell for portable devices, which do not require high voltages but must rather be constructed as thin as possible, but also to fuel cells intended for home use and automobiles.

### Second Embodiment

(Technical Field of the Second Embodiment)

The second embodiment of the present invention relates to a collector and a fuel cell using the collectors. More particularly, the second embodiment relates to a stretchable collector for collecting electrical power from the cell of a small proton-exchange membrane fuel cells.

(Description of the Related Art for the Second Embodiment)

A fuel cell is a device that can generate electric energy from hydrogen and oxygen and can achieve high power efficiency. As opposed to conventional power generating systems, which require conversion of heat energy and kinetic energy into electricity, fuel cells can directly generate power and can thus achieve high power efficiency at small scales. In addition, fuel cells produce less waste such as nitrogen compounds, cause little noises and vibrations and thus do less harm to the environment. Utilizing chemical energy of the fuels and causing less harm to the environment, fuel cells are expected to serve as the energy supply system of the 21st century and have attracted much attention as a promising power generating system that can be used in a wide range of applications, ranging from space technologies and automobiles to portable devices, from large scale to small scale power generation. Thus, significant effort has been devoted to developing this technology.

Proton-exchange membrane fuel cells can operate at lower temperatures and generate power at higher power density as compared to other types of fuel cell. In recent years, one type of proton-exchange membrane fuel cell has drawn particular attention: Direct methanol fuel cells (DMFCs). DMFCs operate by directly feeding aqueous methanol fuel to the anode without any modification. Power is generated by the electrochemical reaction of the methanol solution with oxygen. During this reaction, carbon dioxide is discharged from the anode and water is discharged from the cathode as reaction products. Since methanol aqueous solution can generate more energy per unit volume than hydrogen and is suitable for storage, posing less risk of explosion, DMFCs are expected to become widely used as power sources for automobiles and various portable devices (such as a cell phone, a laptop computer, a PDA, an MP3 player, a digital camera, and an electronic dictionary (book)).

Unlike common fuel cells that are constructed as a stack of cells to obtain increased voltages required for desired purposes, DMFCs for use in portable devices must be small and lightweight and are thus generally formed as a planar array fuel cell (see, for example, Japanese Patent Laid-Open Publication No. 2003-282131).

(Summary of the Invention for Second Embodiment)

In conventional planar fuel cells, however, the plurality of membrane-electrode assemblies (MEAs) arranged in a planar arrangement are held together by fastening the fuel cell from outside. Since these planar fuel cells are not fastened in the central area, the difference in the stretchability between the solid polymer membrane and its peripheral elements (such as collectors) causes these pressed components to come apart if the fuel cells are of the type having an electrolyte layer, such as solid polymer film, that may expand depending on the amount of water it retains (or contract as it dries). The second embodiment of the present invention addresses this problem: It is an object of the second embodiment to provide a collector that can accommodate the expansion and contraction (i.e., stretching and shrinking) of the electrolyte layer used in fuel cells, in particular solid polymer membrane used in proton-exchange membrane fuel cells, and thus is less likely to come off the electrolyte layer. It is also an objective of the second embodiment to provide a fuel cell using such a collector.

To achieve the above-described objective, one aspect according to the second embodiment is a collector for use in a fuel cell that includes an electrolyte layer having two main surfaces, electrodes arranged on both of the main surfaces of the electrolyte layer, and the collector for collecting electricity from the electrodes. The collector can deform as the electrolyte layer deforms. The collector so constructed can accommodate the expansion and contraction (i.e., deformation) of the electrolyte layer used in fuel cells, in particular solid polymer film used in proton-exchange membrane fuel cells, and is less likely to come off the electrolyte layer.

In the above-described aspect, a modulus of elasticity of the collector as measured in a first direction on the main surface may differ from a modulus of elasticity as measured in a second direction on the main surface perpendicular to the first direction. The collector may include at least first fiber and second fiber having different moduli of elasticity. The collector with such a construction can accommodate the deformation of the electrolyte layer, which may deform by different amounts in different directions, and is thus less likely to come off the electrolyte layer.

Another aspect of the second embodiment is a fuel cell that comprises an electrolyte layer having two main surfaces, a first electrode arranged on one of the main surfaces, a second electrode arranged on the other of the main surfaces, a first collector for collecting power from the first electrode, and a second collector for collecting power from the second electrode, wherein at least the first collector is any of the collectors described above.

(Detailed Description of the Invention of the Second Embodiment)

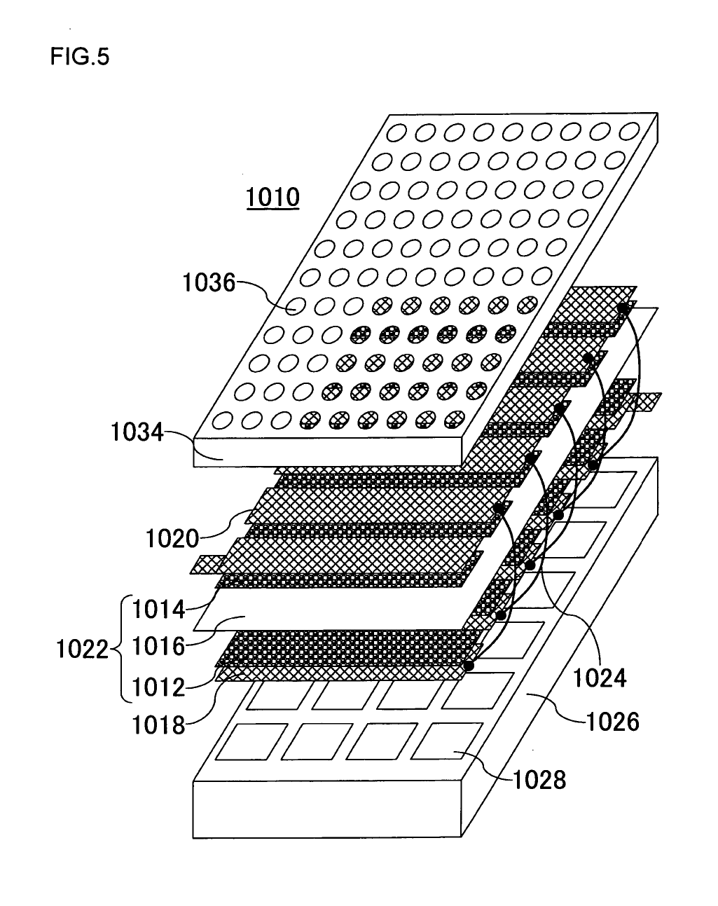

The basic construction of a DMFC 1010 of the second embodiment of the present invention will now be described with reference to FIG. 5. FIG. 5 is an exploded perspective view schematically showing the internal structure of the DMFC 1010. DMFC 1010 comprises a plurality of anodes 1012 to which a methanol solution or pure methanol (referred to collectively as “methanol fuel,” hereinafter) is delivered via capillary action, a plurality of cathodes 1014 to which air is delivered, and an electrolyte membrane 1016 arranged between the anodes 1012 and the cathodes 1014. DMFC 1010 generates power as methanol present in the methanol fuel electrochemically reacts with oxygen in the air. An anode collector 1018 and a cathode collector 1020 are arranged for each MEA 1022. Wirings 1024 connect the anode collectors 1018 to the corresponding cathode collectors 1020, so that a plurality of MEAs 1022 are connected in series. Underneath the anodes 1012 is a methanol fuel storage 1026 to store methanol fuel to be fed to the anodes 1012. The methanol fuel stored in the methanol fuel storage 1026 is fed to the anodes 1012 from respective methanol fuel supply ports 1028 via the collectors 1018. The air spontaneously flowing through respective air inlets 1036 formed on top of a case 1034 is fed to the cathodes 1014.

The anodes 1012 are formed by applying a catalyst paste, which is a mixture of Pt—Ru black and a 5 wt % Nafion solution (DuPont), to one side of a 50 to 200 μm-thick, ion-conductive electrolyte membrane 1016 (in this embodiment, Nafion 115 (DuPont)). Likewise, the cathodes 1014 are formed by applying a catalyst paste, formed as a mixture of Pt black and a 5 wt % Nafion solution (DuPont), to the other side of the electrolyte membrane 1016. Although the electrodes 1012, 1014 are formed on the electrolyte membrane 1016 in this embodiment, they may be deposited on carbon paper or other types of electrode substrate to form a catalyst layer. If the catalyst is capable of catalysis that generates protons from methanol or water from protons and oxygen, it may be used to impregnate carbon black to make catalyst-impregnated carbon. This catalyst can be used in place of Pt—Ru or Pt particles (Pt—Ru black or Pt black).

### EXAMPLE 1

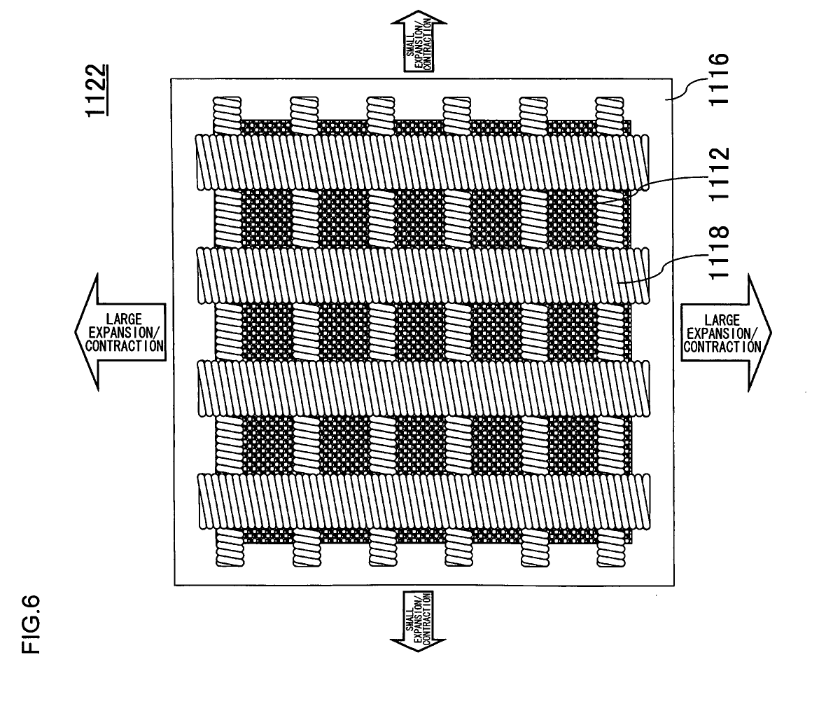

The construction of collector 1118 according to Example 1 of the second embodiment will now be described in detail with reference to FIG. 6. While the construction shown in FIG. 5 includes multiple MEAs 1022 formed on the single electrode membrane 1016, a single MEA 1122 is depicted in FIG. 6 in a top view (as viewed from the anode side) for detailed description of collector 1118. Although the collector of the second embodiment is described only for the anode side, the same description applies to the cathode side as well.

Referring to FIG. 6, the electrolyte membrane 1116 has two directions: a first direction in which the membrane significantly expands or contracts depending on the amount of water it retains (vertical direction in FIG. 6), and a second direction in which the membrane extends or contracts to a lesser extent (horizontal direction in FIG. 6). An electrode 1112 is arranged on the electrolyte membrane 1116 to form an MEA 1122 (with an electrode 1114 arranged on the other side (not shown)). A collector 1118 for collecting power from MEA 1122 is essentially a mesh made of two types of springs with different spring constants so that it can significantly extend or contract in the first direction (vertical direction), but not in the second direction (horizontal direction) as in the electrolyte membrane 1116. The springs are made from gold fiber. Specifically, the collector 1118 shown in FIG. 6 is braided from a first set of coil springs with a relatively small spring constant (warps) and a second set of coil springs with a relatively large spring constant (wefts), forming a fabric-like structure. The two springs are made from gold fibers with the same diameter that are wound to different coil diameters to give different spring constants. Alternatively, gold fibers with different diameters may be wound to the same coil diameter to achieve different spring constants. The springs with small spring constant allow the membrane to expand or contract by a relatively large amount in the vertical direction, whereas the springs with large spring constant allow the membrane to expand or contract by a smaller amount in the horizontal direction than in the vertical direction.

### EXAMPLE 2

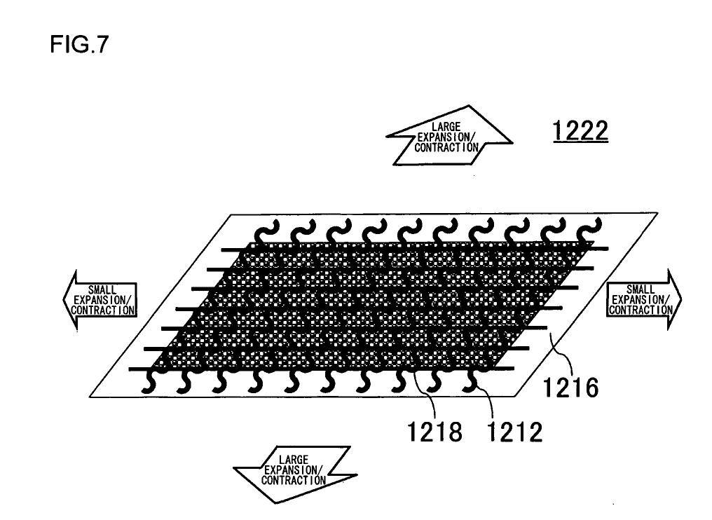

The construction of collector 1218 according to Example 2 of the second embodiment will now be described in detail with reference to FIG. 7. The construction of Example 2 is essentially the same as the construction of Example 1, with the difference being that the warps of Example 1 having small spring constant are replaced with waved gold fibers and the wefts of Example 1 having large spring constant are replaced with common straight gold fibers, as shown in FIG. 7. While in this embodiment, waved gold fibers and straight gold fibers are braided together to form a woven fabric-like collector, wefts may also be made of straight gold fibers. Alternatively, a planar, woven fabric-like collector may be corrugated to make a collector similar to the collector of FIG. 7.

### EXAMPLE 3

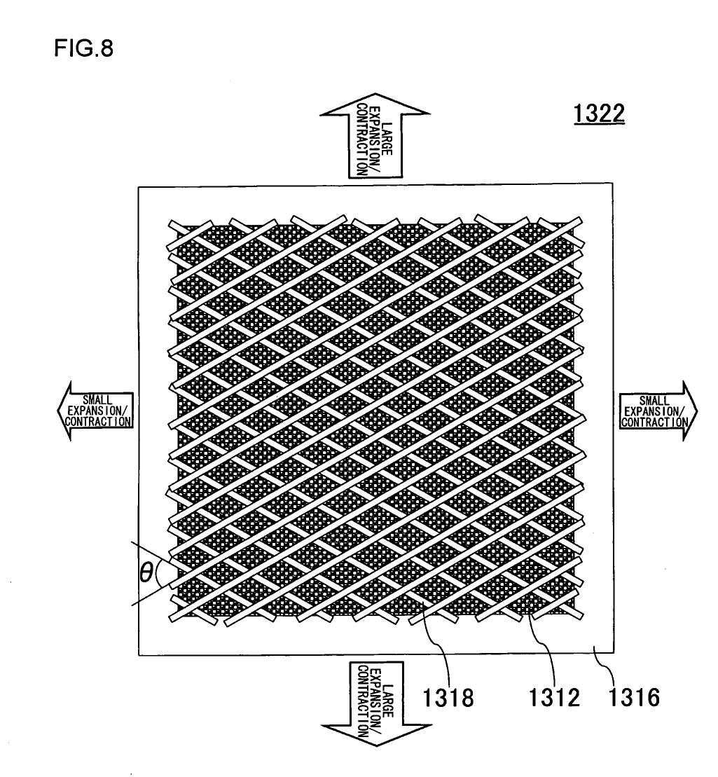

The construction of collector 1318 according to Example 3 of the second embodiment will now be described in detail with reference to FIG. 8. The collector of Example 3 has a woven fabric-like construction with warps and wefts crossing at an oblique angle (θ<90°). The obliquely crossed warps and wefts allow the collector to expand or contract by a large amount in the vertical direction and less in the horizontal direction.

The second embodiment of the collector of the present invention can be applied not only to DMFCs for portable devices, which do not require high voltages but must rather be constructed as thin as possible, but also to fuel cells intended for home use and automobiles.

What is claimed is:

1. A compound membrane having a plurality of regions with different properties, comprising:
a plurality of first regions that conduct protons between first and second main surfaces; and
a second region that conducts electrons between the first and second main surfaces.

2. The compound membrane according to claim 1, further comprising an insulative third region that separates the first regions from one another.

3. The compound membrane according to claim 1, comprising an insulative porous substrate, and wherein the first regions are formed by filling the substrate with a proton conductive material and the second region is formed by filling the substrate with an electron conductive material.

4. A fuel cell, comprising:
the compound membrane according to claim 1;
a plurality of first electrodes arranged on the first main surface, the first electrodes corresponding to, and arranged opposed to, the first regions;
a plurality of second electrodes arranged on the second main surface, the second electrodes corresponding to, and arranged opposed to, the first regions;
a first electron conductive member that connects one of the first electrodes to the second region on the first main surface; and
a second electron conductive member that connects one of the second electrodes that is not opposed to the one of the first electrode to the second region on the second main surface.

5. A fuel cell, comprising:
the compound membrane according to claim 2;
a plurality of first electrodes arranged on the first main surface, the first electrodes corresponding to, and arranged opposed to, the first regions;
a plurality of second electrodes arranged on the second main surface, the second electrodes corresponding to, and arranged opposed to, the first regions;
a first electron conductive member that connects one of the first electrodes to the second region on the first main surface; and
a second electron conductive member that connects one of the second electrodes that is not opposed to the one of the first electrode to the second region on the second main surface.

6. A fuel cell, comprising:
the compound membrane according to claim 3;
a plurality of first electrodes arranged on the first main surface, the first electrodes corresponding to, and arranged opposed to, the first regions;
a plurality of second electrodes arranged on the second main surface, the second electrodes corresponding to, and arranged opposed to, the first regions;
a first electron conductive member that connects one of the first electrodes to the second region on the first main surface; and
a second electron conductive member that connects one of the second electrodes that is not opposed to the one of the first electrode to the second region on the second main surface.

7. The fuel cell according to claim 4, wherein
a region of the compound membrane other than the first region and the second region is not permeable to any fluids other than water.

8. The fuel cell according to claim 5, wherein
a region of the compound membrane other than the first regions and the second region is not permeable to any fluids other than water.

9. The fuel cell according to claim 6, wherein
a region of the compound membrane other than the first regions and the second region is not permeable to any fluids other than water.

10. A collector for use in a fuel cell, the fuel cell including an electrolyte layer having two main surfaces, electrodes arranged on both of the main surfaces of the electrolyte layer, and the collector for collecting electricity from the electrodes, wherein the collector can deform as the electrolyte layer deforms.

11. The collector according to claim 10, wherein
a modulus of elasticity of the collector as measured in a first direction on the main surface differs from a modulus of elasticity as measured in a second direction on the main surface perpendicular to the first direction.

12. The collector according to claim 10, wherein the collector includes at least first fiber and second fiber having different moduli of elasticity.

13. A fuel cell comprising:
an electrolyte layer having two main surfaces;
a first electrode arranged on one of the main surfaces;
a second electrode arranged on the other of the main surfaces;
a first collector for collecting power from the first electrode; and
a second collector for collecting power from the second electrode, wherein
at least the first collector is the collector according to claim 10.

14. A fuel cell comprising:
an electrolyte layer having two main surfaces;
a first electrode arranged on one of the main surfaces;
a second electrode arranged on the other of the main surfaces;
a first collector for collecting power from the first electrode; and
a second collector for collecting power from the second electrode, wherein
at least the first collector is the collector according to claim 11.

15. A fuel cell comprising:
an electrolyte layer having two main surfaces;
a first electrode arranged on one of the main surfaces;
a second electrode arranged on the other of the main surfaces;
a first collector for collecting power from the first electrode; and
a second collector for collecting power from the second electrode, wherein
at least the first collector is the collector according to claim 12.
